(19) United States
(12) Patent Application Publication
(10) Pub. No.: US 2013/0119116 A1
(43) Pub. Date: May 16, 2013

(54) METHOD FOR WELDING HALF SHELLS

(71) Applicants: Christian Lenz, Erlangen (DE); Karsten Niepold, Mulheim (DE); Uwe Zander, Mulheim an der Ruhr (DE)

(72) Inventors: Christian Lenz, Erlangen (DE); Karsten Niepold, Mulheim (DE); Uwe Zander, Mulheim an der Ruhr (DE)

(73) Assignee: SIEMENS AKTIENGESELLSCHAFT, Muenchen (DE)

(21) Appl. No.: 13/811,945

(22) PCT Filed: Jul. 18, 2011
(86) PCT No.: PCT/EP2011/062249

§ 371 Date: Jan. 24, 2013

(30) Foreign Application Priority Data
Jul. 27, 2010 (EP) 10007807.0

(51) Int. Cl. B23K 31/02

(52) U.S. Cl. CPC B23K 31/02
USPC 228/140; 228/101; 228/135

(57) ABSTRACT

A method for welding half shells and thus a method for producing large volume components, such as an inner housing for a steam turbine is disclosed. Two half shells are connected to each other forming a tube-like cross section, and are welded by means of a girth weld to two further half shells that are connected to each other.

### CROSS REFERENCE TO RELATED APPLICATIONS

This application is the US National Stage of International Application No. PCT/EP2011/062249, filed Jul. 18, 2011 and claims the benefit thereof. The International Application claims the benefits of Eurpoean application No. 10007807.0 filed Jul. 27, 2010. All of the applications are incorporated by reference herein in their entirety.

### FIELD OF INVENTION

The invention relates to a method for welding half shells, wherein a first upper half shell and a first lower half shell are connected together and a second upper half shell and a second lower half shell are connected together.

### BACKGROUND OF INVENTION

In steam turbine construction, large-volume components are manufactured from relatively expensive material. Often, it is possible to produce these large-volume components only by means of casting technology methods. Nevertheless, it is often imperative to produce a large component of this type by means of a single casting technology method. Such components usually need to be connected together by complex welding.

Thick-walled half shells are an example of such complex components. The housings for turbomachines, for example for steam turbines, are produced by means of large-volume components. In general, a housing comprises an upper part and a lower part. These upper parts and lower parts resemble the shape of a half shell. Since a full half shell often cannot be produced as a complete casting by means of a single casting technology method, currently two half shells are welded together on the end. However, such half girth bead welds on thick-walled half shells are associated with a large distortion of the component owing to the open structure and the initiated internal stresses due to the energy input into the thick-walled component during the welding owing to impeded thermal expansions. Furthermore, the quality of such weld beads is often reduced.

### SUMMARY OF INVENTION

Often, the welding distortion is estimated before the start of the welding and compensated for in relation to the required final dimensions, in such a way that the parts are straightened as much as possible during the welding. However, in the case of thick-walled components, this is only limitedly possible and it furthermore causes high internal stresses. The invention aims to remedy this.

It is an object of the invention to provide a method with which half shells can be welded together with good geometrical stability during the welding process.

This is achieved by a method for welding half shells, wherein a first upper half shell and a first lower half shell are connected together with a form and/or force fit, wherein a second upper half shell and a second lower half shell are connected together with a form or force fit, wherein the connected first upper and first lower half shells and the connected second upper and second lower half shells are welded together, and a cover is put on during the welding.

The complex welding of two half shells on the end surface is therefore reduced to a technologically known continuous girth weld. Such girth welds are known, for example, from rotor welds. According to the invention, therefore, a first upper half shell and a second lower half shell are initially connected together. In a second step, a second upper half shell is connected together with a second lower half shell. These two half shells which are connected together, and now essentially constitute a full shell, are connected together on an end side. According to the invention, this connection is carried out by means of welding. For reasons of symmetry, distortion during the welding is minimized by the coupling of the components before the welding, since the components formed as full shells present a greater component resistance against the distortion than uncoupled half shells. Furthermore, the final processing of the components can be carried out more rapidly since less distortion is formed after the welding process. The circumferential girth bead permits uninterrupted high-quality girth bead welding, as is possible for tube cross sections.

With the invention, it is therefore possible to produce multipart thick-walled half shells which cannot be produced in one piece owing to casting technology problems. Furthermore, different materials can be combined together in the method according to the invention, which can lead to better utilization of the material properties and a cost saving in procurement.

Furthermore, the internal stresses introduced during the welding, which in the course of the heat retreatment already substantially relax before the horizontal separation of the components, are merely associated with marginal distortions, which leads to improved geometrical constancy of the components in the course of the heat retreatment.

Advantageous refinements are specified in the dependent claims.

In a first advantageous refinement, a girth weld is used.

For reasons of symmetry, girth welds are particularly suitable for connecting rotationally symmetrical bodies together with a form fit.

In another advantageous refinement, the first upper and first lower half shells and/or the second upper and second lower half shells are connected together by means of screws, shrunk rings or covers. The screws, shrunk rings or covers lead to rigidification before the welding. This means that the distortion of the components during the welding process is minimized.

In another advantageous refinement, a suitable heat retreatment is initially carried out after the welding and only then are the first upper and second upper half shells separated from the first lower and second lower half shells at a horizontal part joint. In this way, component distortions which occur during the welding are reduced.

In another advantageous refinement, the half shells are essentially of equal size. By using components of equal size, which at the same time means that these components essentially have the same mass, the welding method can be optimized. Furthermore, component distortions which result from a different mass distribution are effectively prevented.

In another advantageous refinement, the first upper and second upper and the first lower and second lower half shells are formed from different materials. It is therefore possible to weld materially different half shells together. It is also advantageous for the two different materials to be selected in such a way that they have different properties.

For example, a thermally stable material may be used and welded to a low-temperature tough material. In this way—according to requirements—such a component welded together may have both low-temperature toughness and thermal stability properties.

Advantageously, the first upper and first lower half shells are selected from a steel casting, and the second upper and second lower half shells are selected from nickel-based casting. The nickel-based material is in particular outstandingly usable for high-temperature applications. In conjunction with a steel casting for the first upper and the first lower half shells, an overall half shell is thus produced which has outstanding properties in relation to temperature and pressure stability as well as strength. According to the same principle, the first upper and first lower half shells may be selected from a steel casting with high chromium content (highly thermally stable but expensive) and the second upper and the second lower half shells may be selected from a steel casting with low chromium content (not quite as thermally stable but more economical).

### BRIEF DESCRIPTION OF THE DRAWINGS

The invention will be explained in more detail below with the aid of an exemplary embodiment. Components with the same references generally have the same properties.

FIG. 1 shows a representation of four half shells before a first method step;

FIG. 2 shows a representation of the half shells welded together in a second method step and

FIG. 3 shows a representation of the half shells welded together after local separation of the part joint in the region of the girth bead.

### DETAILED DESCRIPTION OF INVENTION

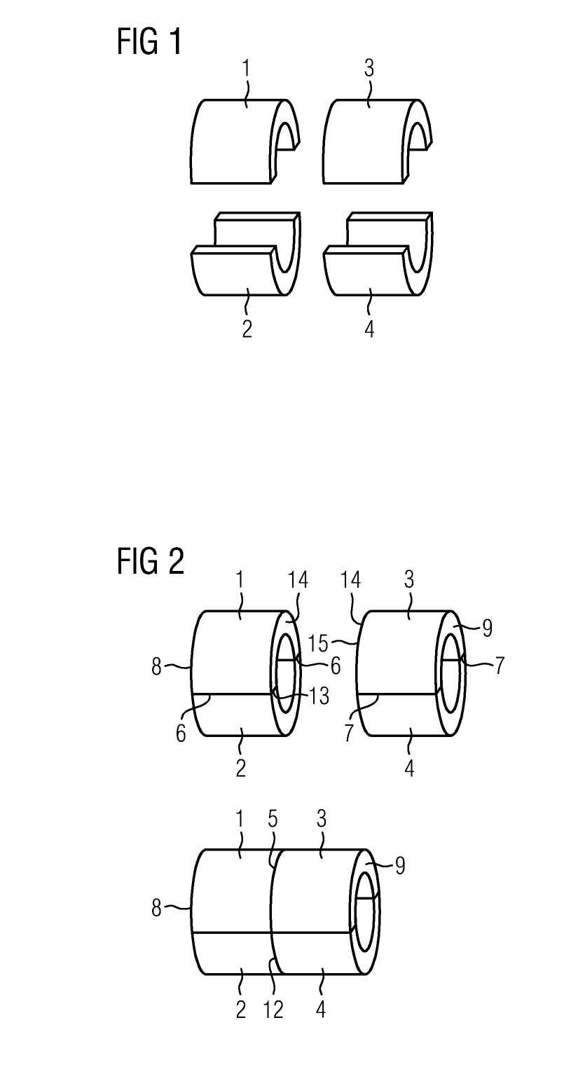

FIG. 1 shows in an exploded representation a first upper half shell 1, a first lower half shell 2, a second upper half shell 3 and a second lower half shell 4. The aforementioned half shells 1, 2, 3, 4 may constitute the inner housing of a turbomachine, for example a steam turbine. Increased thermal and mechanical demands are placed on such housing components.

For instance, these housing components must for example withstand temperatures of up to 700° C. and a pressure of up to 350 bar. Nickel-based materials can generally withstand such high temperatures and pressures.

It is usual to cast such components. After the casting process, the components essentially have the final geometry. However, the geometries or outer dimensions of the components are so large that casting in one piece is not possible. Furthermore, the inner housings of steam turbines have to satisfy differing requirements. For example, the inner housing should preferably have thermal stability properties in a region where the hot and highly pressurized fresh vapor flows in. In a region arranged further behind in the flow direction profile, the steam is at lower temperatures and pressures, for example owing to expansion. The housing should therefore preferably have low-temperature toughness or lower thermal stability properties in this region. In order to satisfy such requirements, different materials are used, which have to be connected together. For example, the first upper 1 and the first lower 2 half shells may be made from a steel casting. The second upper 3 and the second lower 4 half shells may be produced from a relatively expensive nickel-based material. FIG. 1 shows a first method step, according to which the first upper half shell 1, the first lower half shell 2, the second upper half shell 3 and the second lower half shell 4 are essentially formed semicircularly. The first upper half shell 1 and the first lower half shell 2 are essentially of the same size and have essentially similar masses.

This also applies for the second upper 3 and the second lower 4 half shells, which essentially have the same mass and the same size.

FIG. 2 shows a subsequent method step, according to which the first upper half shell 1 and the first lower half shell 2 are preassembled to form a continuous tubular cross section. This is made possible by using screws or other suitable joining elements which can be used with a form and/or force fit. After the aforementioned preassembly, the first upper 1 and the first lower 2 half shells essentially form a ring which is formed so as to be compactly and solidly connected mechanically. Likewise, the second upper half shell 3 and the second lower half shell 4 are preassembled to form a continuous tubular cross section. This is likewise done by using suitable screws or other suitable joining elements, which connect the half shells together with a form and/or force fit.

In a subsequent method step, as shown in FIG. 2, a welding process is carried out which welds together the first upper half shell 1 and the first lower half shell 2 with the second upper half shell 3 and the second lower half shell 4 on the end surface. This process is carried out by continuous welding of a girth bead 5.

The half shells 1, 2, 3, 4 connected with a form and force fit by screws and other joining elements lead to better geometrical stability during the welding process. In the welding process, it is necessary to take care that the input of heat does not exceed any critical value. Good geometrical accuracy of the individual half shells 1, 2, 3, 4 assembled to form a tubular cross section can be improved by, for example, using screws, shrunk rings and covers. The screws are used at part joints 6 and 7. The screws lead to good strength of the half shells connected together. The shrunk rings are arranged around the first upper half shell 1 and the first lower half shell 2, as well as around the second upper half shell 3 and the second lower half shell 4. The shrunk rings are not represented in detail in FIG. 2.

Another possibility for rigidifying the individual half shells 1, 2, 3, 4 assembled to form a tubular cross section can also be improved by the use of covers, which are not represented in detail in FIG. 2. The covers are in this case arranged on an end side 8 or 9 with a force fit to the first upper half shell 1 and the first lower half shell 2, as well as the second upper half shell 3 and the second lower half shell 4.

The rigidification of the structure during the welding and the subsequent heat retreatment leads to a minimal welding distortion and to a cost saving in respect of dimensioning and final processing of the components, since internal stresses introduced during the welding can only cause marginal distortions during the welding and, owing to the dimensional constancy of the components in the course of the heat retreatment, already relax before the separation of the components. The girth bead 12 produced by means of the girth welding permits uninterrupted high-quality girth bead welding, as is known and used with tube cross sections. Use of approach plates and overflow plates is therefore superfluous. When using high-quality and/or expensive material, different materials can be used according to their economic necessity by the multipart method according to the invention. The material properties can therefore be utilized better, which leads to a cost saving in procurement.

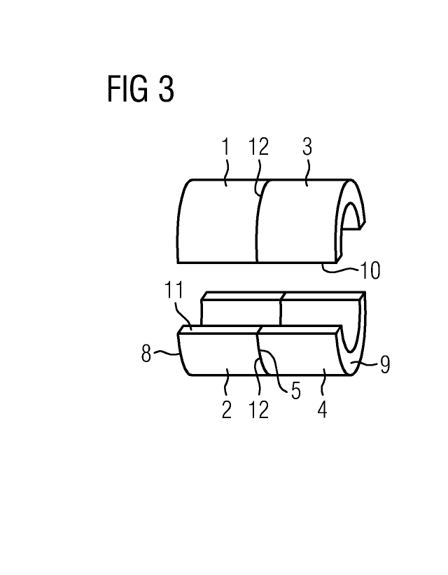

In a subsequent method step, as represented in FIG. 3, an essentially final shape of the overall component is achieved by a subsequent horizontal dividing cut 10 along a part surface 11. By this method step, a common first upper half shell 1 and a second upper half shell 3 are obtained, which are connected together by a girth bead 5. Likewise, a common lower half shell 2 and a second lower half shell 4 are obtained, which are connected together by a girth bead 5. The method according to the invention is outstandingly suitable for the production of housings for steam turbines, which are intended to be produced from different materials, steel casting and nickel-based casting being used. The high-quality material cannot be produced by casting technology in the overall size of the finished component. The production of such large-dimensioned components is nevertheless possible by the method according to the invention. In order to avoid cleavage in the region of the subsequent girth bead 12, the first upper half shell 1 and the first lower half shell 2 are connected together by a connecting weld 13 along an end surface 14. The subsequent separation of the first upper half shell 1 and the first lower half shell 2 horizontally in the part joint 6 then only needs to be carried out locally in the region of the girth bead weld 5.

The same procedure is carried out for the second upper half shell 3 and the second lower half shell 4, which likewise have a connecting weld 15 which in subsequent separation of the half shells horizontally in the part joint 7 only needs to be carried out locally in the region of the girth bead weld 5.

1-8. (canceled)

9. A method for welding half shells, comprising:
forming a first shell by connecting together a first upper half shell and a first lower half shell with a form and/or force fit;
forming a second shell by connected together a second upper half shell and a second lower half shell with a form and/or force fit; and
welding the first shell together with the second shell,
wherein a cover is put on during the welding.

10. The method as claimed in claim 9, wherein a girth weld is used.

11. The method as claimed in claim 9,
wherein the first upper and first lower half shells and/or the second upper and second lower half shells are connected together via screws, shrunk rings or covers.

12. The method as claimed in claim 9, further comprising
separating, after the welding, the first upper half shell from the first lower half shell and second upper half shell from the second lower half shells, the separating at a horizontal part joint.

13. The method as claimed in claim 9,
wherein the half shells are essentially of equal size.

14. The method as claimed in claim 9,
wherein the first upper and second upper and the first lower and second lower half shells are formed from different materials.

15. The method as claimed in claim 9,
wherein a steel casting is used for the first upper and first lower half shells and a nickel-based casting is used for the second upper and second lower half shells.

16. The method as claimed in claim 9,
wherein the first upper and first lower half shells and/or the second upper and second lower half shells are connected together by a connecting weld on the end surface in the region of the subsequent welding, in particular girth bead.
